(19) United States
(12) Patent Application Publication
(10) Pub. No.: US 2013/0266658 A1
(43) Pub. Date: Oct. 10, 2013

(54) Method of producing a PPI-containing pharmaceutical preparation

(71) Applicant: Temmler Werke GmbH, Munchen (DE)

(72) Inventors: Gerd Weiß, Munchen (DE); Thomas Profitlich, Munchen (DE); Karl Schwitzer, Munchen (DE); Cornelia Wagner, Munchen (DE); Manfred Schwitzer, Munchen (DE); Bernhard Huber, Munchen (DE)

(21) Appl. No.: 13/904,924

(22) Filed: May 29, 2013

Related U.S. Application Data
(63) Continuation-in-part of application No. PCT/EP2011/071149, filed on Nov. 28, 2011.

(30) Foreign Application Priority Data
Nov. 29, 2010 (DE) 10 2010 052 847.1

(51) Int. Cl. A61J 3/00

(52) U.S. Cl. CPC A61J 3/00
USPC 424/490; 514/338; 427/2.21

(57) ABSTRACT

The present invention relates to a method of producing a pharmaceutical preparation that contains a proton pump inhibitor and optionally a non-steroidal anti-inflammatory drug in the form of pellets. The invention further relates to pharmaceutical preparations obtainable by said method, in particular those with a defined dissolution profile.

### CROSS REFERENCE TO RELATED APPLICATION

The present invention is a continuation-in-part of PCT Application Serial No. PCT/EP2011/071149 which was filed on Nov. 28, 2011, and which claims priority to German Application Serial No. 10 2010 052 847.1, filed on Nov. 29, 2010, the contents of each of which are hereby incorporated in their entirety by this reference thereto.

### FIELD OF THE DISCLOSURE

The present invention relates to a method of producing a pharmaceutical preparation that contains a proton pump inhibitor and optionally a non-steroidal antirheumatic in the form of pellets. The invention further relates to pharmaceutical preparations obtainable by said method, in particular those with a defined dissolution profile.

### BACKGROUND

Proton pump inhibitors (PPIs) are drugs that suppress the formation of gastric acid by inhibiting H⁺/K⁺-ATPase—a so-called proton pump—in the parietal cells of the stomach. Omeprazole as the best-known drug in the group of proton pump inhibitors has proved useful in the treatment of duodenal ulcer, gastric ulcer, reflux oesophagitis and Zollinger-Ellison syndrome. Both parenteral and solid oral dosage forms are used.

In acidic conditions, omeprazole and its derivatives degrade very rapidly to inactive compounds, and apparently mere contact of the active substance in the solid state of aggregation with acidic groups (of e.g. enteric polymers) leads to degradation. Solid oral dosage forms (tablets, pellets, granules) of omeprazole and similar active substances must therefore be fully protected against the gastric juice. For example, in aqueous solution omeprazole has, at pH values below 2, a half-life of less than 10 minutes (Pilbrandt A. and Cederberg C. Scandinavian Journal of Gastroenterology, 1985, Suppl. 108).

Furthermore, it must be borne in mind that absorption of omeprazole takes place in the upper duodenum, so that it is desirable for release of the active substance to be as rapid as possible after passage through the pylorus.

It is therefore essential for omeprazole to be provided with a coating, which on the one hand is insoluble in the acidic environment of the stomach, but on the other hand dissolves in the neutral to weakly alkaline region of the duodenum.

However, when using coated pellets in pharmaceutical dosage forms it has to be taken into account that these should have a size of well under 2000 μm, to achieve passage through the pylorus and so avoid irregular passage times through the stomach. Conversely, the pellets should have a minimum size of over 500 μm, so that the coating process can be economically efficient, as the surface area increases disproportionately to the weight, and therefore large amounts of coating material are required for the same layer thickness (K. H. Bauer, et al., Coated Pharmaceutical Dosage Forms, CRC Press, 1998, page 133f.). In addition to the preferred particle-size range, a particle-size distribution that is as narrow as possible is also of advantage, to permit uniform filling of capsules used for the administration of pellets. Finally, a method that is as economical as possible, with rapid process steps and relatively high yields is of advantage.

European patent application EP 0 247 983 A2 describes the production of pharmaceutical preparations of omeprazole, wherein the active substance is processed together with an excipient with alkaline reaction into pellet cores, which are then film-coated with an isolating layer and an enteric layer. Although organic solvents and water have been stated to be disadvantageous for the stability of omeprazole, the pellet cores are made using an aqueous omeprazole suspension (with partially dissolved active substance). The method comprises numerous production steps and is therefore time-consuming. Moreover, the use of water during production makes it more difficult to dry the pellets obtained.

The unexamined patent application DE 42 19 390 A1 describes the production of oral dosage forms such as pellets or tablets for pantoprazole, which consist of a core, an intermediate layer and an enteric outer layer. The pellet cores are made by coating sucrose pellets with hydroxypropylmethylcellulose from an aqueous solution and subsequent application of the active substance from an aqueous alcoholic solution in a fluidized bed. This method of production is very restricted, as it requires that certain fillers or binders are not used. In addition, this method is only suitable conditionally for water-sensitive active substances, as the latter decompose if drying is inadequate.

WO 03/080029 A1 discloses the production of pharmaceutical preparations that contain an NO-releasing NSAID. In the production of enteric film-coated pellets, the NO-releasing NSAIDs are suspended in water and sprayed onto porous carrier materials.

WO 97/25064 describes the production of oral pharmaceutical preparations, which in addition to an enteric film-coated PPI can also contain one or more NSAIDs. The pellet cores are made by spraying the pellets in a fluidized bed, wherein water is usually employed as granulating liquid.

There is therefore a need for an improved method of producing pharmaceutical preparations that contain a PPI (proton pump inhibitor) in the form of enteric-coated spherical granules (pellets). Accordingly, the object to be achieved by the invention is to provide a method of producing enteric-coated pellets, with which, in short process times, higher yields of the pellets can be achieved, in a narrow range of particle size. The object is achieved by employing a special agglomeration technique, using a high-speed mixer. In particular, the method is carried out without using water or water-containing granulation liquids, by selecting process parameters that favour a rolling motion of the granules and as a result make it possible to obtain spherical agglomerates.

The method is particularly advantageous when using PPI-containing pellet cores, as the exclusion of water during production means that degradation of the PPI can be avoided as far as possible.

The method has the further advantage that it is largely independent of the physicochemical properties of the active substances to be processed and in particular of the water solubility. Accordingly, it is also possible for several active substances to be processed into spherical pellet cores simultaneously and thus be treated together in the subsequent process steps.

Another advantage of the method described is the short process times and the associated economic effectiveness of manufacture. Compared to the usual techniques such as coating of starter cores in the pelletizing pan or in a fluidized bed and extrusion/spheronization, production of the pellet cores is greatly accelerated, as the preparation of a suspension of the active substance is not required, forming of the spherical granules takes a short time and far shorter drying times are required.

### SUMMARY

The invention relates to a method of producing a pharmaceutical preparation that contains a PPI (proton pump inhibitor) in the form of spherical granules (pellets), comprising the following steps:
(a) granulating the PPI, at least one basic component, at least one pharmaceutically acceptable excipient, and at least one alcohol, preferably ethanol and/or isopropanol, in particular isopropanol, using a high-speed mixer, to obtain PPI-containing cores,
(b) drying the cores,
(c) coating the dried cores with an inert intermediate layer,
(d) film-coating the coated cores with an enteric layer, and
(e) drying the enteric film-coated cores to a residual moisture of less than or equal to 1.5 wt. %, preferably less than or equal to 1 wt. %, to obtain PPI pellets,
   wherein the impeller blade speed of the high-speed mixer is greater than or equal to 50 rev/min, is preferably greater than or equal to 65 rev/min, more preferably is in the range from 70 to 140 rev/min. In an embodiment, the granulation time is preferably less than 20 minutes, more preferably less than or equal to 10 minutes, particularly preferably less than or equal to 8 minutes and most preferably is 5 to 8 minutes.

The granulation in step (a) can take place in the presence of water. However, preferably it takes place without using water or water-containing solvents. It is particularly preferable for granulation to be carried out in the absence of water, if this is technically possible. Absence of water means in this context that the solvent preferably contains not more than 10.0 wt. %, in particular not more than 5.0 wt. %, preferably not more than 1.0 wt. % water. Particularly preferably, 96 vol % ethanol or 99.9 wt. % ethanol or 99.5 wt. % isopropanol is used. It can also be advantageous to use mixtures of solvents.

The invention further relates to a method of producing a pharmaceutical preparation, which in addition to the PPI also contains an NSAID (non-steroidal anti-inflammatory drug) in the form of pellets, wherein the NSAID
(i) in the form of a salt, for example as sodium salt, together with the PPI, is granulated, dried, coated, film-coated and dried again according to steps (a) to (e) and/or
(ii) in free form or in the form of a salt, for example as sodium salt, is granulated, separately from the PPI, together with at least one pharmaceutically acceptable excipient and at least one alcohol, preferably ethanol and/or isopropanol, in particular isopropanol, using a high-speed mixer, to obtain NSAID-containing cores, the cores are dried, film-coated with an enteric layer and the enteric film-coated cores are dried to a residual moisture of less than or equal to 4.0 wt. %, preferably of less than or equal to 3.0 wt. %, particularly preferably of less than or equal to 2.5 wt. %, to obtain enteric film-coated NSAID pellets, and mixing the enteric film-coated NSAID pellets with the (optionally NSAID-containing) PPI pellets, wherein the impeller blade speed of the high-speed mixer is greater than or equal to 50 rev/min, preferably greater than or equal to 65 rev/min, more preferably is in the range from 70 to 140 rev/min.

In an embodiment, the granulation time is preferably less than 20 minutes, more preferably less than or equal to 10 minutes, particularly preferably less than or equal to 8 minutes and most preferably is 5 to 8 minutes.

The granulation of the NSAID both in variant (i) and in variant (ii) preferably takes place without using water or water-containing solvents. It is particularly preferable for granulation to be carried out in the absence of water, if this is technically possible. Absence of water means in this context that the solvent preferably contains not more than 10.0 wt.-%, in particular not more than 5.0 wt. %, preferably not more than 1.0 wt. % water. Particularly preferably, 96 vol % ethanol or 99.9 wt. % ethanol or 99.5 wt. % isopropanol is used. It can also be advantageous to use mixtures of solvents.

In the embodiments described hereinabove, when the NSAID is present, it is present as an immediate release NSAID.

In another embodiment, the pharmaceutical preparation comprises PPI and the immediate release NSAID, and also a delayed release NSAID. In another embodiment, the present invention relates to method of producing a pharmaceutical preparation containing, in addition to the PPI, a NSAID in the form of pellets, and a NSAID enveloping the pellet in a diffusion membrane, wherein a first proportion (portion) of the NSAID
(i) in the form of a salt, together with the PPI, is granulated, dried, coated, film-coated and dried again according to steps (a) to (e) and/or
(ii) in free form or in the form of a salt, and separately from the PPI, is granulated together with at least one pharmaceutically acceptable excipient and at least one alcohol, using a high-speed mixer, to obtain NSAID-containing cores, wherein the cores are dried, film-coated with an enteric layer and wherein the enteric film-coated cores are dried to a residual moisture of less than or equal to 4.0 wt. %, to obtain enteric film-coated NSAID pellets, and mixing the enteric film-coated NSAID pellets with the PPI pellets, wherein the impeller blade speed of the high-speed mixer is greater than or equal to 50 rev/min, and a second proportion (portion) of the NSAID is processed together with at least one pharmaceutically acceptable excipient into NSAID-containing cores and these are coated with a diffusion membrane with delayed permeability for the NSAID, to obtain delayed-release NSAID pellets, wherein the delayed-release NSAID pellets optionally are dried to a residual moisture of less than or equal to 2 wt. %, and mixing the delayed-release NSAID pellets with the PPI pellets and optionally the enteric film-coated NSAID pellets.

In the process described hereinabove, the granulation time is preferably less than 20 minutes, more preferably less than or equal to 10 minutes, particularly preferably less than or equal to 8 minutes and most preferably is 5 to 8 minutes.

In this embodiment, the granulation of the NSAID both in variant (i) and in variant (ii) preferably takes place without using water or water-containing solvents. It is particularly preferable for granulation to be carried out in the absence of water, as defined hereinabove, if this is technically possible. Particularly preferably, 96 vol % ethanol or 99.9 wt. % ethanol or 99.5 wt. % isopropanol is used. It can also be advantageous to use mixtures of solvents.

In the production of delayed-release NSAID pellets it is preferable for the latter to be dried to a residual moisture of less than or equal to 2 wt. %, preferably of less than or equal to 1.5 wt. %, particularly preferably of less than or equal to 1.0 wt. %.

Furthermore, the invention relates to pharmaceutical preparations that are obtainable by this method of production. In an embodiment, the pharmaceutical preparation so described herein is enclosed in a gelatin capsule, which is either a hard or soft capsule, preferably a hard gelatin capsule. In another embodiment, the pharmaceutical preparation is process into tablets, or caplets and the like.

Pharmaceutical preparations of this kind are also preferred with a dissolution rate which, when measured in vitro in a basket apparatus or paddle apparatus according to the European Pharmacopoeia Version 6 in phosphate buffer with an amount of solvent of 900 ml at 100 rev/min and 37° C., essentially corresponds to the following dissolution profile:
(i) after a measuring time of 2 h at pH 1.2, 10% or less, preferably 5% or less of the total PPI has dissolved, and
(ii) after a measuring time of 2 h at pH 1.2 and after a measuring time of 10 min at pH 6.8, 80% or more, preferably 90% or more of the total PPI has dissolved.

### BRIEF DESCRIPTION OF THE DRAWINGS

FIG. 1 shows two release curves of omeprazole-containing pellet cores according to the invention (unvarnished) at a pH of 6.8.

FIG. 2 shows the release curves of the omeprazole-containing pellet cores according to the invention at pH 6.8 after storage in various stress conditions.

FIG. 3a and FIG. 3b show the release curves of the enteric film-coated omeprazole-containing cores according to the invention at pH 6.8 after 2 hours of pretreatment at pH 1.2 or pH 4.5.

FIG. 4 shows the in vitro release profile of enteric diclofenac-containing pellets according to the invention at pH 1.2 (120 min), followed by pH 6.8.

FIG. 5 shows the in vitro release profile of delayed-release diclofenac-containing pellets according to the invention at pH 1.2 (120 min), followed by pH 6.8.

FIG. 6 shows the in vitro release profile of a diclofenac-containing pellet mixture according to the invention at pH 1.2 (120 min), followed by pH 6.8.

FIG. 7 shows the in vitro release profile of an omeprazole-containing and diclofenac-containing pellet mixture according to the invention at pH 1.2 (120 min) and then at pH 6.8.

FIG. 8 shows the in vitro release profile of a combination preparation according to the invention of enteric film-coated pellets comprising 20 mg omeprazole and 25 mg diclofenac at pH 1.2 (120 min) and then at pH 6.8.

FIG. 9 shows the in vitro release profile of a combination preparation according to the invention of enteric film-coated pellets comprising 10 mg omeprazole and 25 mg diclofenac at pH 1.2 (120 min) and then at pH 6.8.

### DETAILED DESCRIPTION

The invention relates to a method of producing a pharmaceutical preparation that contains a PPI (proton pump inhibitor) in the form of spherical granules (pellets), comprising the following steps:
(a) granulating the PPI, at least one basic component, at least one pharmaceutically acceptable excipient, and at least one alcohol, preferably ethanol and/or isopropanol, in particular isopropanol, using a high-speed mixer, to obtain PPI-containing cores,
(b) drying the cores,
(c) coating the dried cores with an inert intermediate layer,
(d) film-coating the coated cores with an enteric layer, and
(e) drying the enteric film-coated cores to a residual moisture of less than or equal to 1.5 wt.-%, preferably less than or equal to 1 wt.-%, to obtain PPI pellets,

wherein the impeller blade speed of the high-speed mixer is greater than or equal to 50 rev/min, is preferably greater than or equal to 65 rev/min, more preferably is in the range from 70 to 140 rev/min. In an embodiment, the granulation time is preferably less than 20 minutes, more preferably less than or equal to 10 minutes, particularly preferably less than or equal to 8 minutes and most preferably is 5 to 8 minutes. Particularly preferably, the granulating in step (a) takes place in the absence of water, as defined above.

In this method it is particularly preferable if in step (a), magnesium carbonate is used as the basic component and isopropanol as the alcohol, in particular at an impeller blade speed of the high-speed mixer in the range from 70 to 140 rev/min, because then at a granulating time of less than or equal to 10 minutes (even better, less than or equal to 8 minutes and best of all 5 to 8 minutes), PPI-containing pellets can be obtained that are characterized by a narrow particle-size distribution and a high yield of spherical pellets in the range from 700 μm to 1250 μm.

The PPI, as used herein, is preferably omeprazole, esomeprazole, lansoprazole, pantoprazole or rabeprazole, in particular omeprazole.

In another embodiment, the method according to the invention is used for producing a pharmaceutical preparation that in addition to the PPI, also contains an NSAID (non-steroidal anti-inflammatory drug) in the form of pellets, wherein the NSAID is present in free form or in the form of a salt, for example as sodium salt or as potassium salt, together with the PPI, is granulated, dried, coated, film-coated and dried again according to steps (a) to (e), so that PPI pellets are obtained in which the cores contain both a PPI and an NSAID.

Alternatively, the pharmaceutical preparation that contains, in addition to the PPI, also an NSAID in the form of pellets, can be produced by granulating the NSAID in free form or in the form of a salt, for example as sodium salt or as potassium salt, separately from the PPI, together with at least one pharmaceutically acceptable excipient and at least one alcohol, preferably ethanol and/or isopropanol, in particular isopropanol, preferably in the absence of water, as defined above (e.g. using 96 vol % ethanol or 99.9 wt. % ethanol or 99.5 wt. % isopropanol), using a high-speed mixer, to obtain NSAID-containing cores, the cores are dried, film-coated with an enteric layer and the enteric film-coated cores are dried to a residual moisture of less than or equal to 4.0 wt. %, preferably of less than or equal to 3.0 wt. %, particularly preferably of less than or equal to 2.5 wt. %, to obtain enteric film-coated NSAID pellets, and mixing the enteric film-coated NSAID pellets with the (optionally NSAID-containing) PPI pellets, wherein the impeller blade speed of the high-speed mixer is greater than or equal to 50 rev/min, preferably greater than or equal to 65 rev/min, more preferably is in the range from 70 to 140 rev/min. In an embodiment, the granulation time is preferably less than 20 minutes, more preferably less than or equal to 10 minutes, particularly preferably less than or equal to 8 minutes and most preferably is 5 to 8 minutes.

The method according to the invention has the advantage that it makes it possible to produce pharmaceutical preparations that allow the simultaneous administration both of PPIs, e.g. omeprazole, and of NSAIDs, e.g. diclofenac. Moreover, in another embodiment, the NSAID is preferably partly contained in enteric-coated pellets, and partly in delayed-release NSAID pellets. In the method of producing these pharmaceutical preparations, a proportion of the NSAID is processed together with at least one pharmaceutically acceptable excipient into NSAID-containing cores and the latter are enveloped in a diffusion membrane with delayed permeability for the NSAID, to obtain delayed-release NSAID pellets. Optionally the delayed-release NSAID pellets are dried to a residual moisture of less than or equal to 2 wt. %, preferably of less than or equal to 1.5 wt. %, particularly preferably of less than or equal to 1.0 wt. %. The optionally dried delayed-release NSAID pellets are then mixed with the PPI pellets and optionally the enteric NSAID pellets.

The NSAID, as described herein, is preferably selected from diclofenac, ibuprofen, ketoprofen, naproxen, indometacin, piroxicam, meloxicam, acetylsalicylic acid, celecoxib, parecoxib and etoricoxib. In the context of the present invention it is particularly preferable to use diclofenac, in particular diclofenac sodium, as the NSAID.

In the method according to the invention the molar ratio of NSAID in enteric pellets to NSAID in delayed-release pellets is 0.1:1 to 1:1, preferably 0.5:1 to 1:1, in particular 0.5:1.

According to the method according to the invention it is particularly preferable for the PPI pellets to have, after production, a water content of less than or equal to 1.0 wt. %, preferably of less than or equal to 0.5 wt. %.

The at least one basic component that is used in the method according to the invention is a pharmaceutically acceptable base. Examples include magnesium carbonate, magnesium oxide, magnesium hydroxide, aluminium carbonate, aluminium hydroxide, calcium carbonate, calcium phosphate, calcium citrate, sodium carbonate, sodium hydrogen carbonate, sodium phosphate, sodium citrate, potassium carbonate, potassium phosphate and/or potassium citrate, preferably magnesium carbonate.

By alcohol it is meant an alcohol having 1-10 carbon atoms, in particular 1-5 carbon atoms. Examples include methanol, ethanol, isopropanol, propanol, butanol, isobutanol, tert-butanol, sec-butanol, pentanol, hexanol, heptanol, octanol, decanol and the like, or mixtures thereof, preferably ethanol, isopropanol or propanol, more preferably ethanol or isopropanol, in particular isopropanol.

The at least one pharmaceutically acceptable excipient used in the method according to the invention is preferably mannitol, sorbitol, isomalt, colloidal silica, microcrystalline cellulose, dextrin, maltodextrin, maize starch, sucrose, lactose and/or sodium lauryl sulphate, preferably mannitol and/or sodium lauryl sulphate.

The inert intermediate layer described above comprises in particular hydroxypropylcellulose, hydroxypropylmethylcellulose, polyvinylpyrrolidone, polyvinyl alcohol and mixtures thereof, in particular hydroxypropylmethylcellulose. The inert intermediate layer can further contain anti-adherents such as talc.

The enteric layer is preferably selected independently from: methacrylic acid-ethylacrylate copolymer, methacrylic acid-methylmethacrylate copolymer, polyvinylacetate phthalate, hydroxypropyl methylcellulose acetate phthalate, cellulose acetate phthalate, and hydroxypropyl methylcellulose acetate succinate, in particular methacrylic acid-ethylacrylate copolymer, e.g. Eudragit L 30 D-55®. The enteric layer can further contain plasticizers such as polyethylene glycol (e.g. PEG 6000) or triethyl citrate, anti-adherents such as talc and/or white pigment such as titanium dioxide.

It may be appreciated that the excipients described hereinabove may be combined with additional pharmaceutical adjuncts normally found in pharmaceutical compositions in order to prepare the pharmaceutical preparations of the present invention contain of the. These additional ingredients are known to one of ordinary skill in the art. Examples of these additional ingredients include, but are not limited to, one or more of the following: additional excipients; surface active agents; dispersing agents; inert diluents; granulating and disintegrating agents; binding agents; lubricating agents; sweetening agents; flavoring agents; coloring agents; preservatives; physiologically degradable compositions such as gelatin; suspending agents; dispersing or wetting agents; emulsifying agents, demulcents; buffers; salts; thickening agents; fillers; antioxidants; stabilizing agents; and pharmaceutically acceptable polymeric or hydrophobic materials.

The components are then mixed in a high speed mixer as described in the process described herein.

The high-speed mixers used in the method according to the invention are preferably those that are obtainable from DIOSNA Dierks & Sane GmbH, Germany (e.g. Diosna P1200 or VAC 1200), Glatt Prozess Technology GmbH, Germany (e.g. Glatt VG 1500 or TDG1500), L. B. Bohle Maschinen+Verfahren GmbH, Germany, Collette/GEA Pharma Systems AG, Switzerland (e.g. Collette Gral 1200), Zanchetta/I.M.A. Industria Macchine Automatiche S.p.A., Italy, Fielder-Aeromatic/GEA Pharma Systems AG, Switzerland and Gebr. Lödige Maschinenbau GmbH, Germany.

In another embodiment, the present invention relates to a pharmaceutical preparation obtainable by a method according to the invention, in particular a preparation that contains omeprazole as PPI and diclofenac, in particular diclofenac sodium as NSAID. Moreover, it is particularly preferable if the diclofenac is both in the form of enteric-coated pellets and in the form of delayed-release pellets. Moreover, it is particularly advantageous if the proportions by weight omeprazole:diclofenac sodium (enteric coated):diclofenac sodium (delayed-release) are 1.0:1.0-3.0:1.5-5.0, in particular 1.0:1.25-2.5:2.5-5.0, preferably 1.0:1.25:2.5 or 1.0:2.5:5.0, particularly preferably 1.0:1.25:2.5.

In a particularly advantageous embodiment, the present invention provides a pharmaceutical preparation, obtainable with the method according to the invention, wherein the pellets have a dissolution rate which, when measured in vitro in a basket apparatus or paddle apparatus according to the European Pharmacopoeia Version 6 in aqueous phosphate buffer in 900 ml (or 1000 ml) at 100 rev/min and 37° C., essentially corresponds to the following dissolution profile: after a measuring time of 10 min, at pH 6.8, 80% or more, preferably 90% or more of the PPI is released.

In another particularly advantageous embodiment, the present invention provides a pharmaceutical preparation, obtainable with the method according to the invention, wherein the pellets have a dissolution rate which, when measured in vitro in a basket apparatus or paddle apparatus according to the European Pharmacopoeia Version 6 in hydrochloric acid or aqueous phosphate buffer in 900 ml in water at 100 rev/min and 37° C., essentially corresponds to the following dissolution profile: (i) after a measuring time of 2 h at pH 1.2, 10% or less, preferably 5% or less of the total PPI has dissolved, and (ii) after a measuring time of 2 h at pH 1.2 and after a measuring time of 10 min at pH 6.8, 80% or more, preferably 90% or more of the total PPI has dissolved.

In another particularly advantageous embodiment, the present invention provides a pharmaceutical preparation, obtainable with the method according to the invention, wherein the enteric film-coated pellets have a dissolution rate which, when measured in vitro in a basket apparatus or paddle apparatus according to the European Pharmacopoeia Version 6 in hydrochloric acid or aqueous phosphate buffer in 900 ml of water at 100 rev/min and 37° C., essentially corresponds to the following dissolution profile: (i) after a measuring time of 2 h at pH 1.2, 10% or less, preferably 5% or less of the NSAID has dissolved, and (ii) after a measuring time of 1 h (following the two-hour measurement at pH 1.2 and/or as independent measurement) at pH 6.8, 80% or more of the NSAID has dissolved.

In another particularly advantageous embodiment, the present invention provides a pharmaceutical preparation, obtainable with the method according to the invention which, when measured in vitro in a basket apparatus or paddle apparatus according to the European Pharmacopoeia Version 6 in hydrochloric acid or aqueous phosphate buffer in 900 ml of water at 100 rev/min and 37° C., essentially has the following dissolution rate:
(i) after a measuring time of 2 h at pH 1.2, 10% or less, preferably 5% or less of the total PPI and 10% or less, preferably 5% or less of the total NSAID have dissolved,
(ii) after a measuring time of 10 min at pH 6.8, 80% or more, preferably 90% or more of the total PPI has dissolved, and
(iii) after a measuring time of 1 h at pH 6.8, 40 to 70% of the total NSAID has dissolved, and over a period of a further measuring time of 5 h at pH 6.8, a further 2.5 to 10% of the total NSAID per h has dissolved.

The measurements described above (ii) and (iii) at a pH of 6.8 can be carried out following measurement (i) at pH 1.2, but even without previous measurement (i) at a pH of 1.2. The composition according to the invention, which comprises both PPI pellets and NSAID pellets, preferably shows:
(a) a very small release (i.e. 10% or less, preferably 5% or less) of the respective active substances within 120 min at pH 1.2,
(b) a very rapid release of the PPI (above 80%, preferably above 90%) over a very short period (in 20 min or less, in particular in 10 min or less) at pH 6.8,
(c) a very rapid release of a proportion of the NSAID (about 40 to 70%, in particular about 50 to 60%) over a short period (40 to 80 min, in particular about 40 to 60 min) at pH 6.8, and a delayed release of a proportion of the NSAID (about 20 to 60%, in particular about 30 to 50%) after the rapid release over a longer period (about 5 h or more, preferably about 7 h or more, particularly preferably about 12 h or more), wherein in particular a dissolution rate of the NSAID from 2.5%/h to 10%/h, preferably from 4%/h to 8%/h over this longer period is advantageous.

In another particularly advantageous embodiment, the present invention provides a pharmaceutical preparation that comprises PPI-containing and NSAID-containing pellets, wherein:

the PPI-containing pellets comprise a core, which comprises the PPI, at least one basic component and at least one pharmaceutically acceptable excipient, wherein the core is coated with an inert intermediate layer and is film-coated with an enteric layer, and

a proportion of the NSAID-containing pellets comprise a core, which comprises NSAID and at least one pharmaceutically acceptable excipient, wherein the core is film-coated with an enteric layer, and

another proportion of the NSAID-containing pellets comprise a core, which comprises NSAID and at least one pharmaceutically acceptable excipient, wherein the core is enveloped in a diffusion membrane with delayed permeability for the NSAID, wherein:

the NSAID is in free form or in the form of a salt, for example as sodium salt,

the pharmaceutical preparation contains 5 mg to 40 mg, preferably 10 mg to 30 mg, in particular 10 mg, 15 mg, 20 mg or 30 mg of PPI, and 50 mg to 150 mg, preferably 50 mg, 75 mg or 150 mg, in particular 75 mg of NSAID. In an embodiment,

the PPI is selected from omeprazole, esomeprazole, lansoprazole, pantoprazole and rabeprazole, preferably from omeprazole, and the NSAID is selected from diclofenac, ibuprofen, ketoprofen, naproxen, indometacin, piroxicam, meloxicam, acetylsalicylic acid, celecoxib, parecoxib and etoricoxib, preferably from diclofenac,

and the at least one basic component is selected independently from the group consisting of: magnesium carbonate, magnesium oxide, magnesium hydroxide, aluminium carbonate, aluminium hydroxide, calcium carbonate, calcium phosphate, calcium citrate, sodium carbonate, sodium hydrogen carbonate, sodium phosphate, sodium citrate, potassium carbonate, potassium phosphate and potassium citrate, and is preferably magnesium carbonate.

In yet another quite particularly advantageous embodiment according to the invention the pharmaceutical preparation comprises PPI-containing and NSAID-containing pellets, wherein:

the PPI-containing pellets comprise a core, which comprises the PPI, at least one basic component and at least one pharmaceutically acceptable excipient, wherein the core is coated with an inert intermediate layer and is film-coated with an enteric layer, and

a proportion of the NSAID-containing pellets comprise a core, which comprises the NSAID and at least one pharmaceutically acceptable excipient, wherein the core is film-coated with an enteric layer, and

another proportion of the NSAID-containing pellets comprise a core, which comprises the NSAID and at least one pharmaceutically acceptable excipient, wherein the core is enveloped in a diffusion membrane with delayed permeability for the NSAID,

wherein:

the pharmaceutical preparation contains 5 mg to 40 mg, preferably 10 mg to 30 mg, in particular 10 mg, 15 mg or 20 mg of PPI, and 50 mg to 150 mg, preferably 50 mg, 75 mg or 150 mg, in particular 75 mg of NSAID. In an embodiment, the PPI is in the form of omeprazole and the NSAID is in the form of diclofenac or diclofenac sodium, and the at least one basic component is magnesium carbonate.

The pharmaceutical preparations according to the invention, which comprise both PPI and NSAID, wherein the PPI is rapid-release and the NSAID is partly rapid-release and partly delayed-release, have the advantage that (i) there is rapid onset of action of the NSAID, (ii) the necessary blood level of the NSAID is maintained over a period of several hours and (iii) side effects of the NSAID, which may develop particularly in long-term use, such as gastric and intestinal complaints, which may be caused by inhibition of COX-1 present in the gastric mucosa, are reduced or even completely avoided through the simultaneous administration of a PPI. In addition, compliance is promoted, as it is not necessary to take two or even three different medicines. In addition this increases safety of use.

The pharmaceutical preparation of the present invention can be made into oral dosage forms, such as tablets, capsules, caplets, and the like using techniques known in the art.

For example, the pellets are in one embodiment, fill or are enclosed in gelatine capsules, for example, hard gelatin capsules, using techniques known in the art.

The pharmaceutical composition of the invention may be prepared, packaged, or sold in bulk, as a single unit dose, or as a plurality of single unit doses. As used herein, a “unit dose” is discrete amount of the pharmaceutical composition comprising a predetermined amount of the PPI, and when present, the NSAID. The amount of the PPI, and when present, NSAID, is generally equal to the dosage of the PPI, or when present, NSAID, which would be administered to a subject or a convenient fraction of such a dosage such as, for example, one-half or one-third of such a dosage.

The relative amounts of the PPI, and when present, NSAID, the pharmaceutically acceptable vehicle, and any additional ingredients in a pharmaceutical composition of the invention will vary, depending upon the identity, size, and condition of the subject treated and further depending upon the route by which the composition is to be administered. By way of example, the composition may comprise between 0.1% and 100% (w/w) PPI and NSAID, when present. A unit dose of a pharmaceutical composition of the invention will generally comprise from about 1 microgram to about 1 gram of PPI, and preferably comprises from about 100 micrograms to about 100 milligrams of PPI.

If a NSAID is additionally present in the unit dosage form, it is present from about 100 micrograms to about 5 grams, and preferably comprises from about 500 micrograms to about 500 milligrams.

For example, in embodiments of the present invention, the pharmaceutical preparation may contain from about 5 mg to about 40 mg, preferably about 10 mg to about 30 mg, in particular about 10 mg, about 15 mg or about 20 mg of PPI, and from about 50 mg to about 150 mg, preferably about 50 mg, about 75 mg or about 150 mg, in particular about 75 mg of NSAID in total, when present in immediate-release form or when present both as immediate release form and delayed release form.

The pharmaceutical preparation prepared in accordance with the present invention is, in an embodiment, useful for treating duodenal ulcer, dyspepsia, gastroesophageal reflux disease, gastric ulcer, reflux oesophagiis and Zollinger-Ellison syndrome and the like.

When a NSAID is additionally present, whether the NSAID is present as an immediate release NSAID or an immediate release NSAID in combination with a delayed release NSAID, the pharmaceutical preparation of the present invention is, in addition, useful for the treatment for treating pain and inflammation in a patient in need of said treatment especially those associated with or resulting from a condition selected from rheumatism, contusions, sprain and arthritis. In another embodiment, this pharmaceutical preparation of the present invention is useful for treating pain and inflammation in a patient having rheumatism. In another embodiment, when diclofenac (in the form of diclofenac in free form or as a salt, such as sodium salt) is present as NSAID, whether present as an immediate release NSAID or an immediate release NSAI in combination with a delayed release NSAID, and omeprazole is present as PPI, the pharmaceutical preparation of the present invention is particularly useful in the symptomatic treatment of rheumatoid arthritis, osteoarthritis, and ankylosing spondylitis (Morbus Bechterew) in patients with a previous history or who are at risk of developing NSAID associated gastric and/or duodenal ulcers.

As used herein the term “treat or treatment” refers to an approach for obtaining beneficial or desired results, including clinical results. Beneficial or desired clinical results include but are not limited to alleviation, amelioration, palliation and/or elimination of the condition being treated in a patient resulting from the administration of the pharmaceutical preparation of the present invention.

The patient, e.g., mammal, such as a human, is given a therapeutically effective amount of the pharmaceutical preparation. As used herein “therapeutically effective amount” is that amount of the pharmaceutical preparation that when administered to a subject suffering from the condition described herein will have the intended therapeutic effect, e.g., alleviation, amelioration, palliation or elimination of the condition being treated. The full therapeutic effect does not necessarily occur by administration of one dose and may occur only after administration of a series of doses. Thus, a therapeutically effective amount may be administered in one or more administrations.

A subject or patient, as used herein, is a mammal, preferably a human but can be a mammal in need of veterinary treatment, e.g., dog, cat, cows, sheep, pigs, horses, mules, and the like.

It is understood that the ordinarily skilled physician or veterinarian will readily determine and prescribe an effective amount of the compound to treat, ameliorate, relieve, inhibit, prevent, reduce a condition in the subject or to elicit an immune response. In so proceeding, the health care professional may, for example, prescribe a relatively low dose at first, subsequently increasing the dose until an appropriate response is obtained. It is further understood, however, that the specific dose level and regimen for administration for any particular subject will depend upon a variety of factors including the specific compound proton pump inhibitor and if present, the NSAID employed, the age, body weight, general health, gender, and diet of the subject, the time of administration, the route of administration, the rate of excretion, any drug combination, and the severity of the condition. The pharmaceutical preparation would contain the proton pump inhibitor and the NSAID, if present, necessary to deliver a therapeutically effective dose.

The following non-limiting examples further exemplify the present invention.

The following examples illustrate the production and characterization of the method according to the invention and its use for producing the pharmaceutical preparations. Although these examples describe special embodiments of the invention, they only serve for illustrating the invention and should not be construed as limiting the invention in any way. As a person skilled in the art is aware, numerous changes can be made, while remaining within the scope of protection of the invention, as defined by the appended patent claims.

### EXAMPLES

It should be pointed out that percentages, unless stated otherwise in the present application, refer to percentage by weight (wt. %).

The residual moisture (water content) of the enteric or delayed-release film-coated cores (PPI pellets or NSAID pellets) after drying was determined by Karl Fischer titration according to the European Pharmacopoeia, Version 6, (e.g. on the Methrom KF Titrino 701 instrument) using Hydranal reagents.

The loss on drying was measured with a Halogen moisture measuring instrument, e.g. Mettler Toledo HR73, at 85° C. for 10 min.

### Example 1

### Titration Tests on Omeprazole Pellet Cores with Various Base Components

For optimization of the pellet core, various base components were added to recipes not containing an active substance, consisting of mannitol, hydroxypropylcellulose and sodium lauryl sulphate, and they were then titrated with 0.1 N HCl. Various amounts of Na₂HPO₄, MgCO₃ and meglumine were used for this.

The purpose of the investigations was to select a base with good buffering action for the pellet core, to avoid degradation of the omeprazole on penetration of small amounts of acid during passage through the stomach (or during testing of resistance to gastric juice). Furthermore, after opening of the enteric polymer, there should be a slightly alkaline pH, in order to avoid possible degradation of the active substance in vivo.

For Na₂HPO₄, a range of 0.5-1.0 g was investigated. Larger amounts were not used, as Na₂HPO₄ has hygroscopic properties, which can have an adverse effect on omeprazole stability. For MgCO₃ (obtainable e.g. from Merck KGaA, Darmstadt, Germany or from Magnesia, Luneburg, Germany) a range from 1 g to 10 g was investigated, and for meglumine (N-methyl-D-glucamine) from 1 g to 5 g (in each case relative to 79 g of pellet cores without active substance).

For purposes of comparison, a recipe without base in the pellet core was also included in the test series.
The results, which are shown in Tables 1a and 1b, can be summarized as follows:
The recipe without base does not show any buffering action; the pH after suspending in water is in the slightly acidic range (approx. pH 6.1) after stirring for approx. 15 min.
Adding MgCO₃ to the mixture of excipients brings about an increase in pH after suspending in water to approx. pH 9.5 to 10. Although the pH values of the recipes with 1 g to 10 g of MgCO₃ in water only differ slightly, a definite increase in buffering action can be seen with a larger amount of base. Much larger amounts of acid can be neutralized before there is a decrease in pH.
Adding Na₂HPO₄ to the mixture of excipients also brings about alkalization of the suspension. At approx. pH 8.0-8.5, the values are somewhat lower than with MgCO₃, and the buffering action is also much less pronounced.
Meglumine shows behaviour similar to that of MgCO₃ with pH values of the aqueous suspension of approx. pH 10 and comparable buffering action.

TABLE 1a
The buffering action of different bases

| | Without base | | MgCO₃ recipes | | | | | | | |
|---|---|---|---|---|---|---|---|---|---|---|
| | Quantity | Quantity | Quantity | Quantity | Quantity | Quantity | Quantity | Quantity | Quantity | Quantity |
| Excipient | [g] | [wt.-%] | [g] | [wt.-%] | [g] | [wt.-%] | [g] | [wt.-%] | [g] | [wt.-%] |
| Mannitol | 78.00 | 98.7 | 77.00 | 97.5 | 73.00 | 92.4 | 68.00 | 86.1 | 68.00 | 86.1 |
| MgCO₃ heavy | — | — | 1.00 | 1.27 | 5.00 | 6.3 | 10.00 | 12.7 | — | — |
| MgCO₃ light | — | — | — | — | — | — | — | — | 10.00 | 12.7 |
| Hydroxypropylcellulose | 0.50 | 0.63 | 0.50 | 0.63 | 0.50 | 0.63 | 0.50 | 0.63 | 0.50 | 0.63 |
| Sodium lauryl sulphate | 0.50 | 0.63 | 0.50 | 0.63 | 0.50 | 0.63 | 0.50 | 0.63 | 0.50 | 0.63 |
| Total excipients | 79.00 | 100 | 79.00 | 100 | 79.00 | 100 | 79.00 | 100 | 79.00 | 100 |

| | | | | | |
|---|---|---|---|---|---|
| pH (10% suspension) | 6.12 | 9.69 | 9.58 | 9.87 | 9.87 |
| Consumption of 0.1N | 0 | approx. 2.5 ml | 10 ml | >10 ml | >10 ml |
| HCl up to about pH 8.0 | | | | | |
| Consumption of 0.1N | 0 | <5 ml | n.d. | n.d. | n.d |
| HCl up to about pH 7.0 | | | | | |

n.d.: not determined

TABLE 1b
The buffering action of different bases

| | Na₂HPO₄ recipes | | | | | | Meglumine recipes | | | |
|---|---|---|---|---|---|---|---|---|---|---|
| | Quantity | Quantity | Quantity | Quantity | Quantity | Quantity | Quantity | Quantity | Quantity | Quantity |
| Excipient | [g] | [wt.-%] | [g] | [wt.-%] | [g] | [wt.-%] | [g] | [wt.-%] | [g] | [wt.-%] |
| Mannitol | 77.50 | 98.1 | 77.00 | 97.5 | 77.00 | 97.5 | 77.00 | 97.5 | 73.00 | 92.4 |
| Na₂HPO₄ × 2H₂O | 0.50 | 0.63 | 1.00 | 1.27 | — | — | — | — | — | — |
| Na₂HPO₄ (anhydrous) | — | — | — | — | 1.00 | 1.27 | — | — | — | — |
| Meglumine | — | — | — | — | — | — | 1.00 | 1.27 | 5.00 | 6.3 |
| Hydroxypropylcellulose | 0.50 | 0.63 | 0.50 | 0.63 | 0.50 | 0.63 | 0.50 | 0.63 | 0.50 | 0.63 |
| Sodium lauryl sulphate | 0.50 | 0.63 | 0.50 | 0.63 | 0.50 | 0.63 | 0.50 | 0.63 | 0.50 | 0.63 |
| Total excipients | 79.00 | 100 | 79.00 | 100 | 79.00 | 100 | 79.00 | 100 | 79.00 | 100 |

| | | | | | |
|---|---|---|---|---|---|
| pH (10% suspension) | 8.19 | 8.34 | 8.34 | 9.85 | 10.06 |
| Consumption of 0.1N | <0.03 ml | 0.04 ml | 0.03 ml | 2.4 ml | 12 ml |
| HCl up to about pH 8.0 | | | | | |
| Consumption of 0.1N | 0.25 ml | 0.46 ml | 0.54 ml | 2.6 ml | 12.4 ml |
| HCl up to about pH 7.0 | | | | | |

### Example 2

### Omeprazole Pellet Yields as a Function of the Process Conditions/Production Scale

The influence of various process parameters in the production of the pellet cores (amount of isopropanol (granulating agent) added, granulating time, mixer speed) on pellet yield was investigated at the production scale (total amount of solids in the batch 300 kg).

The results are presented in the following table:

| | Amount of | | | Yield of |
|---|---|---|---|---|
| | granulating agent | | | 700-1250 μm |
| | (isopropanol) | Granulating time | Mixer | pellets |
| Batch | (kg) | (min) | (rev/min) | (kg) |
| A | 50-53 | 25-30 | 40 | 10-20 |
| B | 50-53 | 17-19 | 40 | 50-60 |
| C | 56-59 | 10-15 | 50 | 65-75 |
| D | 56-59 | 10-15 | 60 | 80-90 |
| E | 62-65 | 9-10 | 65 | 120-140 |
| F | 62-65 | 5-8 | 70-80 | 170-200 |

It can be seen that pellet yield in the particularly important range of 700-1250 μm can be increased markedly in particular by shortening the granulation time to less than 20 minutes (in particular to less than or equal to 8 minutes), by increasing the amount of granulating agent and by increasing the mixer speed during granulation to greater than or equal to 50 rev/min, in particular to greater than or equal to 65 rev/min.

### Example 3

### Production Examples for Omeprazole Pellets

Recipes with different proportions of active substance and excipients can be prepared by the method described. Table 2 below gives recipe examples with reference to the composition of the pellet core, of the protective layer and of the enteric layer. The recipe examples given relate to batch sizes of 1 kg of pellet cores.

TABLE 2
Recipe examples of omeprazole pellets

| Recipe example | 1 | 2 | 3 | 4 | 5 |
|---|---|---|---|---|---|
| Pellet core | | | | | |
| Omeprazole | 100 | 180 | 180 | 360 | 540 |
| Mannitol | 874 | 760 | 755 | 515 | 330 |
| Magnesium carbonate | 20 | 50 | 50 | 100 | 100 |
| Hydroxypropylcellulose | 1 | 5 | 5 | 5 | 10 |
| Sodium lauryl sulphate | 5 | 5 | 10 | 20 | 20 |
| Intermediate layer | | | | | |
| Hydroxypropyl- | 3.12 | 3.12 | 4.35 | 4.35 | 4.35 |
| cellulose (6 cP) | | | | | |
| Magnesium carbonate | 4.87 | 4.87 | — | — | — |
| Talc | 3.12 | 3.12 | 4.35 | 4.35 | 4.35 |
| Enteric layer | | | | | |
| Eudragit L30-D55 (solid) | 35.01 | 35.01 | 31.06 | 24.15 | 31.06 |
| NaOH for pH-adjustment | q.s. | q.s. | — | q.s. | — |
| to pH 5.2 | | | | | |
| Talc | 7.00 | 7.00 | 12.42 | 9.66 | 12.42 |
| PEG 6000 | 3.50 | 3.50 | — | 2.42 | — |
| Triethyl citrate | — | — | 3.11 | — | 3.11 |
| Titanium dioxide | 2.10 | 2.10 | — | 2.10 | — |

The weighed components of the pellet core are transferred to a pharmaceutically usual high-speed mixer and are mixed. While mixing/granulating continuously, isopropanol is added to the powder mixture in the mixer until pellets of the required quality (roundness, diameter approx. 1 mm) are formed. The mixing time is 1 to 10 min, usually 5 to 8 min, to achieve a suitable quality and yield.

The pellets moistened with isopropanol are then dried in a dryer at an inlet air temperature of approx. 50-70° C. for approx. 30-60 min until a loss on drying of less than 1 wt.-%, preferably less than 0.3 wt.-% is obtained. The pellets with the desired diameter of less than 2 mm, in particular those with a diameter from 700 to 1250 μm are then separated by sieving.

The pellets are then varnished (film-coated) in suitable process conditions in a fluidized bed with the aqueous suspension of the intermediate layer (produced by usual pharmaceutical techniques) and, after an intermediate drying step, with the aqueous suspension of the enteric layer (produced by usual pharmaceutical techniques), and are then dried until the residual moisture (water content) is less than or equal to 1.5 wt.-%, preferably less than or equal to 1 wt.-%.

The enteric film-coated pellets are then sieved and filled in hard gelatin capsules.

### Example 4

### Release and Stability of the Omeprazole Pellets

### Pellet Cores

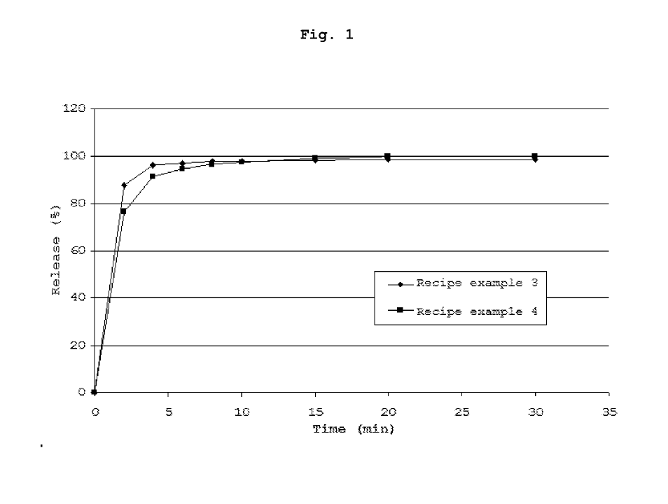

The dissolution rate of omeprazole from the pure pellet cores was measured using a paddle apparatus according to the European Pharmacopoeia Version 6, at 100 rev/min and 37° C., in phosphate buffer with an amount of solvent of 900 mL and a pH of 6.8. The dissolved (or released) omeprazole was determined using a release measuring apparatus from the company Distec (Premiere 5100 Dissolution System with Agilent 8453 UV-online system) with UV-online absorption measurement at 301 nm and background correction at 345 nm using quartz cuvettes with a layer thickness from 5 mm to 10 mm. The dissolution rate of omeprazole for the recipe examples 3 and 4 is shown in the form of a graph in FIG. 1.

As can be seen from this figure, the pellet cores quickly disintegrate and release the active substance very rapidly in the release test, i.e. within 10 min; more than 95% of the omeprazole has dissolved.

To determine the stability of the pellet cores, pellet cores prepared according to recipe example 3 were stored in stress conditions and then the dissolution rate of omeprazole was investigated as described above.

The following stress conditions were applied:

Rcp 3 Recipe example 3, untreated

W02/40 40° C., 75% air humidity, open glass vessel, 2 weeks

W02/60 60° C., closed glass vessel, 2 weeks

M01/25 25° C., 60% air humidity, open glass vessel, 1 month

M01/40 40° C., 75% air humidity, open glass vessel, 1 month

W02/40 PE 40° C., 75% air humidity, closed PE bottle & drying agent (silica gel), 2 weeks

M03/25 25° C., 60% air humidity, open glass vessel, 3 months

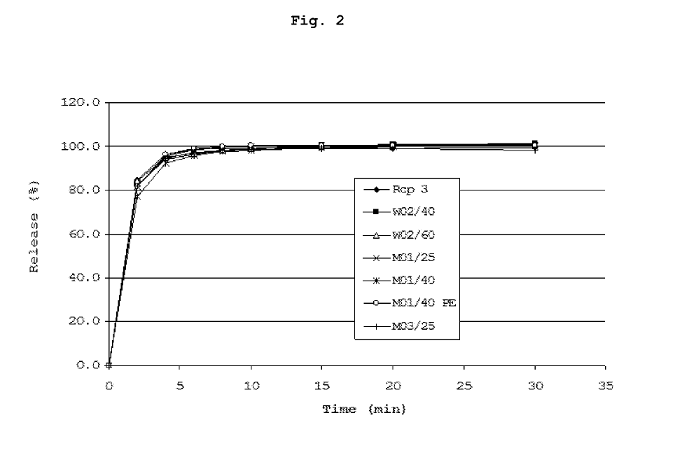

The dissolution rates are given in Table 3 and are illustrated in graph form in FIG. 2.

TABLE 3
Dissolution rate of recipe example 3

| | Release (%) | | | | | | |
|---|---|---|---|---|---|---|---|
| Time | | W02/ | | | | | |
| (min) | Rcp 3 | 40 | W02/60 | M01/25 | M01/40 | M01/40 PE | M03/25 |
| 0 | 0.0 | 0.0 | 0.0 | 0.0 | 0.0 | 0.0 | 0.0 |
| 2 | 84.6 | 82.5 | 84.4 | 81.7 | 77.1 | 81.5 | 82.0 |
| 4 | 96.2 | 94.0 | 94.9 | 95.5 | 92.4 | 96.4 | 94.5 |
| 6 | 98.5 | 96.3 | 97.0 | 98.5 | 96.0 | 98.9 | 97.1 |
| 8 | 99.0 | 97.9 | 98.0 | 99.5 | 97.9 | 100.0 | 98.2 |
| 10 | 99.1 | 99.0 | 99.0 | 100.0 | 98.0 | 100.3 | 98.7 |
| 15 | 99.3 | 100.3 | 100.1 | 100.2 | 99.3 | 100.5 | 99.0 |
| 20 | 99.2 | 100.8 | 100.7 | 100.4 | 100.0 | 100.5 | 98.9 |
| 30 | 99.3 | 101.1 | 100.7 | 100.4 | 100.1 | 100.4 | 98.3 |

As can be seen from these investigations, the pellet cores prepared according to recipe example 3 have excellent stability, and even after storage in stress conditions, they release the active substance completely very rapidly within 10 min. This excellent stability might be due to the chemical structure and the low residual moisture of the pellet cores.

### Example 4a

Pellet cores were film-coated with a protective layer and an enteric layer as described hereinabove in recipe examples 1-5. The composition is shown in the following Table 4. The recipe example given relates to a batch size of 1 kg of pellet cores.

TABLE 4
Comparative recipe example of omeprazole pellets

| Recipe example | 4a |
|---|---|
| Pellet core | |
| Omeprazole | 100 |
| Mannitol | 790 |
| Anhydrous lactose | 40 |
| Microcrystalline cellulose | 20 |
| Disodium hydrogen phosphate dihydrate | 10 |
| Hydroxypropylcellulose | 30 |
| Sodium lauryl sulphate | 10 |
| Intermediate layer | |
| Hydroxypropylcellulose (6 cP) | 4.35 |
| Talc | 4.35 |
| Enteric layer | |
| Eudragit L30-D55 (solid) | 24.15 |
| NaOH for pH-adjustment to pH 5.2 | q.s. |
| Talc | 9.66 |
| PEG 6000 | — |
| Triethyl citrate | 2.42 |
| Titanium dioxide | 2.10 |

The recipe examples 2 and 3 and the recipe example 4a were filled in hard gelatin capsules in a pellet quantity corresponding to 20 mg omeprazole and were stored for stress stability testing over 2 weeks. Storage was open at 40° C./75% relative humidity and closed in a glass bottle with screw closure at 60° C. The pellets were then investigated with respect to the total amount of impurities by HPLC analysis in comparison with the initial value. The results obtained are shown in the following Table 5.

TABLE 5
Comparative stability testing of omeprazole pellets

| | Total amount of impurities (area %) | | |
|---|---|---|---|
| | Recipe | Recipe | Recipe |
| Storage conditions | example 2 | example 3 | example 4a |
| Start | 0.10 | 0.10 | 0.06 |
| 2 weeks open | 0.45 | 0.37 | 6.01 |
| 40° C./75% RH | | | |
| 2 weeks closed | 0.47 | 0.51 | 1.85 |
| glass bottle, 60° C. | | | |

As can be seen from this table, all three compositions are stable. However, recipe examples 2 and 3, which contain magnesium carbonate, are much more stable than example 5, in which sodium dihydrogen phosphate was used.

Enteric Varnished (Film-Coated) Pellets

As omeprazole is not stable in an acid medium, various amounts of enteric layer (Eudragit L30-D55) were applied on the pellet cores according to recipe example 3 and the stability of the coated cores was investigated as follows.

To determine the resistance to gastric juice, omeprazole-containing cores film-coated (varnished) with different film thicknesses were exposed using a paddle apparatus according to the European Pharmacopoeia Version 6, at 100 rev/min and 37° C., for two hours to an amount of solvent of 500 mL at pH 1.2 (hydrochloric acid medium) or pH 4.5 (sodium acetate buffer). Then the release medium was decanted, the cores were isolated and the amount of intact omeprazole was determined using analysis by high-performance liquid chromatography with UV-absorption measurement at 280 nm. The percentage ratio of the omeprazole content after release testing for two hours to the omeprazole content before release testing is designated as resistance to gastric juice (%). The results are shown in Table 6.

TABLE 6
Stability of enteric-coated omeprazole cores

Resistance to gastric juice (%)

| Enteric coating applied (%)* | pH 1.2 | pH 4.5 |
|---|---|---|
| 10.0 | <50 | <50 |
| 15.0 | 72 | <50 |
| 20.0 | 97 | 91 |
| 25.0 | 96 | 93 |
| 27.5 | 97 | 97 |
| 30.0 | 100 | 100 |

*Enteric coating applied (%): ratio by weight of enteric layer (varnish) to total weight (core, intermediate layer and enteric layer)

It can be seen that to achieve the desired resistance to gastric juice, application of 20% or more, preferably 25% or more of enteric varnish layer is required, even to achieve a corresponding resistance to gastric juice. Layer thicknesses of at least 20% release hardly any active substance and protect the active substance against chemical attack by the acidic medium.

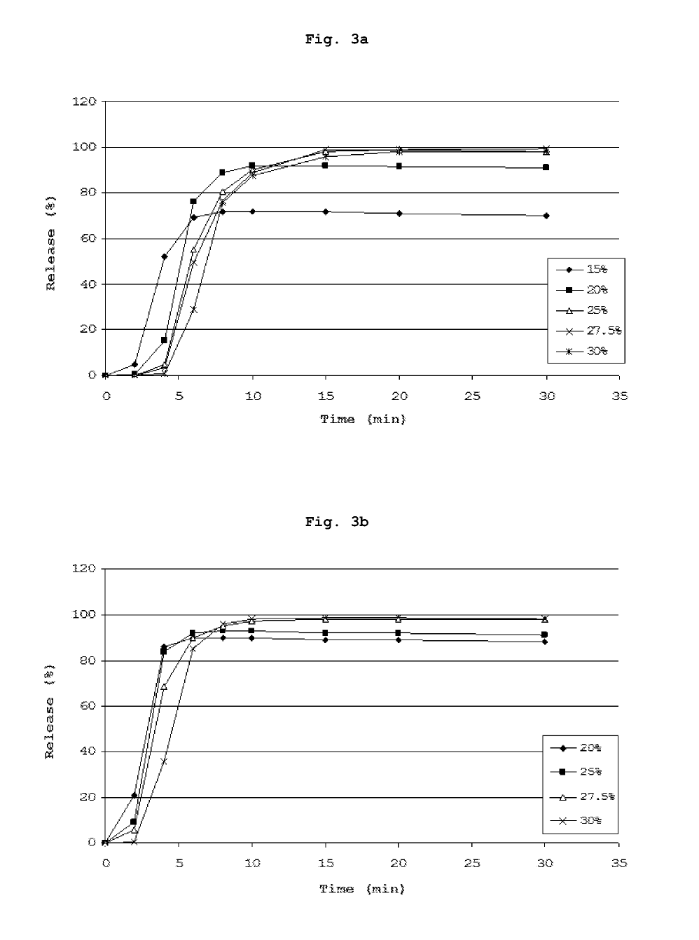

Next, the pH of the dissolution medium was changed, by adding 400 ml of suitably concentrated phosphate buffer solution, to pH 6.8 (which reflects the neutral pH environment of the intestine). As can be seen from FIG. 3a and FIG. 3b, at pH 6.8 with varnish application of at least 25%, the active substance is released to over 80% within 10 min and to over 90% within 20 min. During gastric juice resistance testing, the pH has only a slight influence on the dissolution rate.

### Example 5

### Production Examples for Diclofenac Pellets

The following Table 7 gives recipe examples relating to the composition of diclofenac-containing pellet cores with an enteric or delayed-release layer. The recipe examples given relate to batch sizes of 1 kg of pellet cores.

TABLE 7
Recipe examples of diclofenac pellets

| Recipe example | 6 | 7 |
|---|---|---|
| Pellet core | | |
| Diclofenac sodium | 500 | 500 |
| Microcrystalline cellulose | 440 | 440 |
| Polyvinylpyrrolidone | 40 | 40 |
| Colloidal silica | 20 | 20 |
| Enteric layer | | |
| Eudragit L30-D55 (solid) | 200 | — |
| NaOH for pH-adjustment to pH 5.2 | q.s. | — |
| Propylene glycol | 20 | — |
| Talc | 100 | — |
| Delayed-release layer | | |
| Eudragit RS100 | — | 40 |
| Eudragit RL100 | — | 8.0 |
| Triethyl citrate | — | 4.8 |
| Talc | — | 36 |

The weighed components of the pellet core are transferred to a pharmaceutically usual high-speed mixer, and are mixed. While mixing/granulating continuously, isopropanol is added to the powder mixture in the mixer until pellets of the required quality (roundness, diameter approx. 1 mm) are formed. The mixing time is 1 to 10 min, usually 5 to 8 min, to achieve a suitable quality and yield.

The pellets moistened with isopropanol are then dried in a dryer at an inlet air temperature of approx. 50-70° C. for approx. 30-60 min until a loss on drying of less than 2 wt. %, better still less than 1.0 wt. % is obtained. The pellets with the desired diameter of less than 2 mm, in particular those with a diameter from 700 to 1250 μm, are then separated by sieving.

For enteric varnishing, the pellets are then varnished (film-coated) in the process conditions described above in a fluidized bed with the aqueous suspension of the enteric polymer, in which propylene glycol is dissolved and talc is suspended (preparation according to usual pharmaceutical techniques), and then dried, until the residual moisture (water content) is less than or equal to 4.0 wt. %, preferably less than or equal to 3.0 wt. %, particularly preferably less than or equal to 2.5 wt. %.

For delayed-release varnishing, the pellets are varnished (film-coated) in the process conditions described above in a fluidized bed with an organic solution (isopropanol/acetone) of the delayed-release polymer, in which triethyl citrate is dissolved and talc is suspended (produced by usual pharmaceutical techniques), and then dried, until the residual moisture (water content) is less than or equal to 2 wt.-%, preferably less than or equal to 1.5 wt.-%, particularly preferably less than or equal to 1.0 wt.-%.

The film-coated pellets are then sieved, mixed and filled in hard gelatin capsules.

### Example 6

### Release of the Diclofenac Pellets

Release Curves of Diclofenac Pellets

The dissolution rates of the diclofenac pellets of recipe examples 6 and 7 and of a mixture thereof were investigated at various pH values. For this purpose, enteric film-coated pellets containing 25 mg diclofenac sodium, delayed-release varnished pellets containing 50 mg diclofenac sodium, and a mixture of enteric varnished pellets containing 25 mg diclofenac sodium and delayed-release varnished pellets containing 50 mg diclofenac sodium were investigated.

A rotating basket apparatus according to the European Pharmacopoeia Version 6 was used, with an amount of solvent of 1000 ml at 100 rev/min and 37° C. After 2 hours of release testing using hydrochloric acid medium (pH 1.2), the release medium was changed to phosphate buffer (pH 6.8) and the dissolution rate was investigated for up to a further 6 hours. The diclofenac dissolved was determined with UV-absorption measurement at 281 nm.

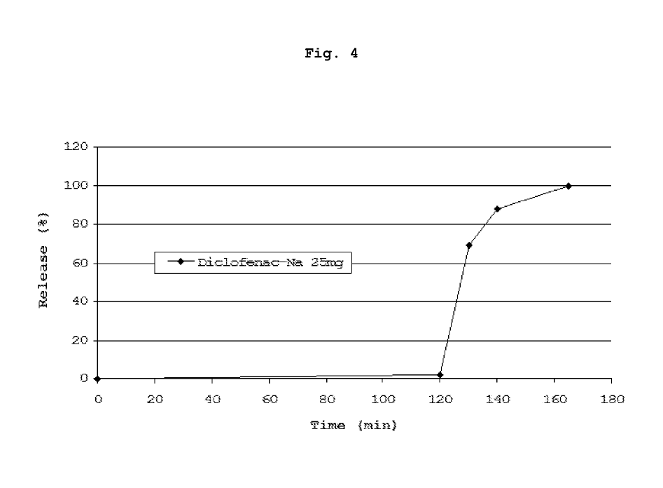

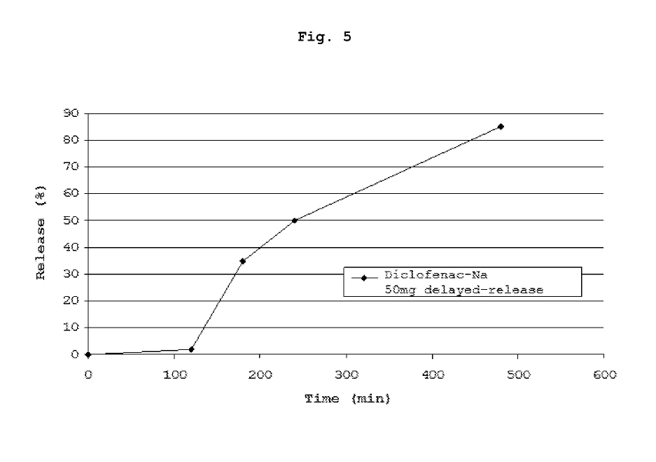

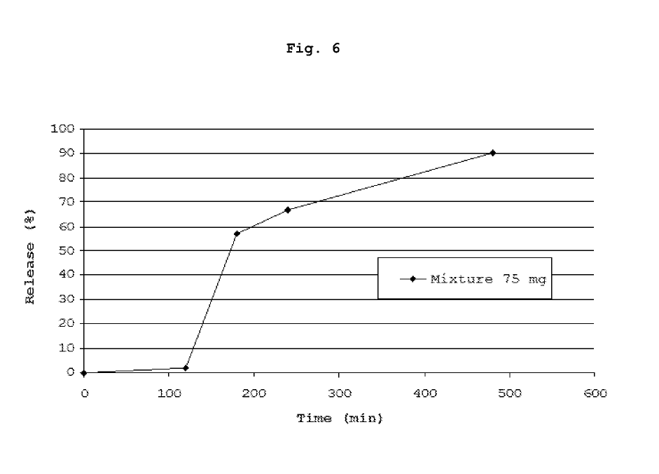

The dissolution rates are given in Table 8, Table 9 and Table 10 and are shown in graph form in FIG. 4, FIG. 5 and FIG. 6.

TABLE 8
Dissolution rates of recipe example 6

| | pH 1.2 | pH 1.2 | pH 6.8 | pH 6.8 | pH 6.8 |
|---|---|---|---|---|---|
| Time (min) | 0 | 120 | 130 | 140 | 165 |
| Release (%) | 0 | 2 | 69 | 88 | 100 |

TABLE 9
Dissolution rates of recipe example 7

| | pH 1.2 | pH 1.2 | pH 6.8 | pH 6.8 | pH 6.8 |
|---|---|---|---|---|---|
| Time (min) | 0 | 120 | 180 | 240 | 480 |
| Release (%) | 0 | 2 | 35 | 50 | 85 |

TABLE 10
Dissolution rates of a mixture of recipe examples 6 and 7

| | pH 1.2 | pH 1.2 | pH 6.8 | pH 6.8 | pH 6.8 |
|---|---|---|---|---|---|
| Time (min) | 0 | 120 | 180 | 240 | 480 |
| Release (%) | 0 | 2 | 57 | 67 | 90 |

Pharmacological Significance of the Release Profile

The following information can be deduced from the release curves:
At pH 1.2 there is hardly any release of diclofenac sodium
After change of pH to pH 6.8 there is complete release of diclofenac from the enteric-coated pellets within 45 min
After change of pH to pH 6.8, release from the delayed-release coated pellets takes place continuously over a period of more than 6 hours
After change of pH to pH 6.8, the pellet mixture shows addition of the aforementioned diclofenac sodium releases with the advantage of rapid release of the enteric portion (initial dose) and slow release of the delayed-release portion (continuous dose) over a period of 6 hours or more.

This ensures, in vivo, a rapid onset of action (via the initial dose of the enteric portion) and maintenance of suitable blood levels over an extended period (via the delayed-release portion), which is particularly advantageous pharmacologically, in particular for treating rheumatoid complaints.

### Example 7

### Pharmaceutical Preparation Containing a Combination of Omeprazole and Diclofenac Pellets

A hard gelatin capsule was filled with enteric film-coated omeprazole pellets according to the invention (containing a total of 20 mg omeprazole), enteric film-coated diclofenac sodium pellets (containing a total of 25 mg diclofenac sodium) and with delayed-release diclofenac sodium pellets (containing a total of 50 mg diclofenac sodium) to obtain a pharmaceutical composition that contains a combination of both active substances. The enteric film-coated omeprazole pellets were prepared according to Example 3 (recipe example 3). The enteric film-coated and the delayed-release diclofenac sodium pellets were prepared according to Example 5 (recipe examples 6 and 7 respectively).

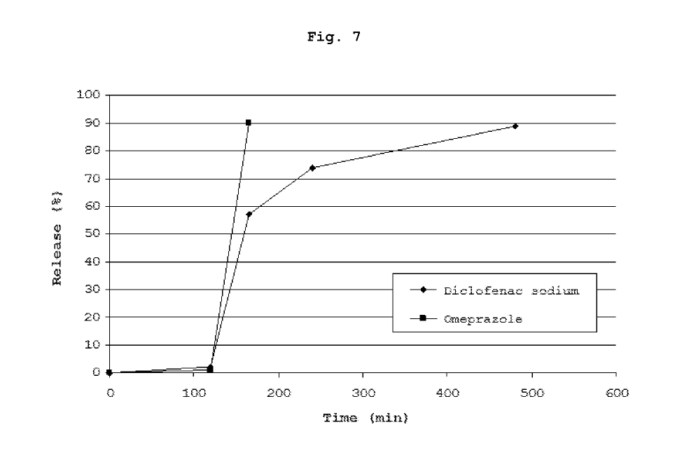

Then the release of the active substances was investigated at different pH values. A rotating basket apparatus according to the European Pharmacopoeia Version 6 was used, with an amount of solvent of 900 ml at 100 rev/min and 37° C. After 2 hours of release testing using hydrochloric acid medium (pH 1.2) the release medium was changed to phosphate buffer (pH 6.8) and the dissolution rate was monitored for a further 6 hours. The two active substances were determined by separation by high-performance liquid chromatography with UV-absorption measurement at 280 nm. The omeprazole released after 2 hours was determined indirectly by determining the residual omeprazole content of the isolated pellets in parallel gastric juice resistance testing using identical test conditions (pH 1.2 for 2 hours). The dissolution rates are given in Table 11 and are shown in graph form in FIG. 7.

TABLE 11
Dissolution rate of the combination preparation

| | pH 1.2 | pH 1.2 | pH 6.8 | pH 6.8 | pH 6.8 |
|---|---|---|---|---|---|
| Time (min) | 0 | 120 | 165 | 240 | 480 |
| Omeprazole | 0 | 1* | 90 | not | not |
| release (%) | | | | determined | determined |
| Diclofenac | 0 | 2 | 57 | 74 | 89 |
| release (%) | | | | | |

*Figure relating to the residual omeprazole content in gastric juice resistance testing in identical test conditions (pH 1.2 for 2 hours)

### Example 8

### Enteric Film-Coated Pellets Containing a Combination of Omeprazole and Diclofenac

Enteric film-coated pellets that contain a combination of omeprazole and diclofenac sodium in varying proportions can also be prepared according to the method described in Example 3. The following Table 12 gives recipe examples for the composition of the pellet core, the protective layer and the enteric layer. The recipe examples given relate to batch sizes of 1 kg of pellet cores.

TABLE 12
Recipe examples of enteric film-coated pellets
that contain omeprazole and diclofenac

| Recipe example | 8 | 9 | 10 |
|---|---|---|---|
| Pellet core | | | |
| Omeprazole | 250 | 180 | 90 |
| Diclofenac sodium | 250 | 225 | 270 |
| Mannitol | 430 | 520 | 560 |
| Magnesium carbonate | 50 | 50 | 50 |
| Hydroxypropylcellulose | 10 | 15 | 25 |
| Sodium lauryl sulphate | 10 | 10 | 5 |
| Intermediate layer | | | |
| Hydroxypropylcellulose (6 cP) | 4.35 | 4.35 | 3.12 |
| Magnesium carbonate | — | — | 4.87 |
| Talc | 4.35 | 4.35 | 3.12 |
| Enteric layer | | | |
| Eudragit L30-D55 (solid) | 31.06 | 31.06 | 35.01 |
| NaOH for pH-adjustment to pH 5.2 | — | — | q.s. |
| Talc | 12.42 | 12.42 | 7.00 |
| PEG 6000 | — | — | 3.50 |
| Triethyl citrate | 3.11 | 3.11 | — |
| Titanium dioxide | — | — | 2.10 |

The enteric film-coated pellets obtained by the method of production according to the invention are sieved and filled in hard gelatin capsules. Then enteric film-coated pellets are filled in the hard gelatin capsules in a dosage of 20 mg omeprazole and 25 mg diclofenac sodium, and in a dosage of 10 mg omeprazole and 25 mg diclofenac sodium.

The release of the active substances from the dosage forms according to recipe examples 9 and 10 was investigated at various pH values, as in the procedure described in Example 7 (rotating basket apparatus, 900 ml, 100 rev/min, 37° C.). After 2 hours of release testing, the medium was changed from pH 1.2 to pH 6.8 and measurement of the dissolution rate was continued for a further 45 minutes. The two active substances were determined by analysis as described in Example 7.

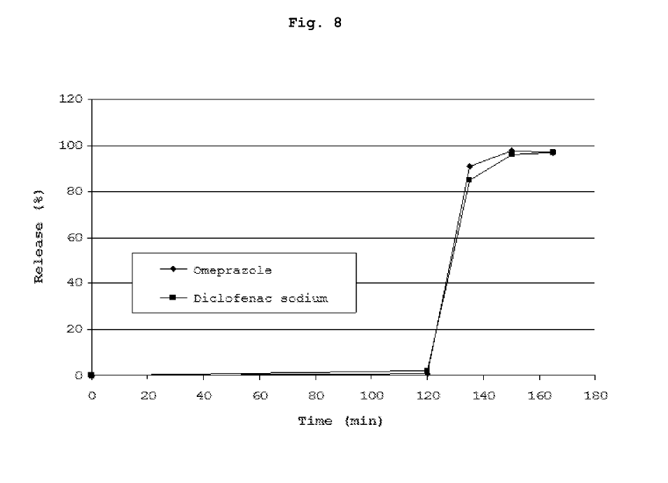

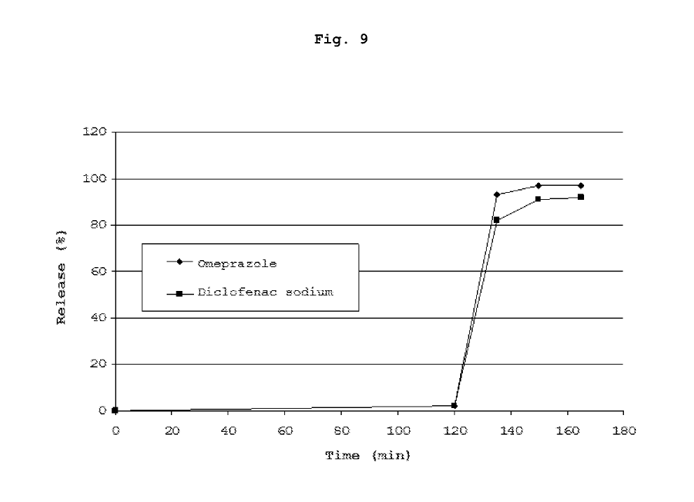

The dissolution rates are given in Table 13 and Table 14 and are shown in graph form in FIG. 8 and FIG. 9.

TABLE 13
Dissolution rate of a combination preparation comprising
20 mg omeprazole and 25 mg diclofenac sodium

| | pH 1.2 | pH 1.2 | pH 6.8 | pH 6.8 | pH 6.8 |
|---|---|---|---|---|---|
| Time (min) | 0 | 120 | 135 | 150 | 165 |
| Omeprazole release (%) | 0 | 1* | 91 | 98 | 97 |
| Diclofenac release (%) | 0 | 2 | 85 | 96 | 97 |

*Figure relating to the residual omeprazole content in gastric juice resistance testing in identical test conditions (pH 1.2 for 2 hours)

TABLE 14
Dissolution rate of a combination preparation comprising
10 mg omeprazole and 25 mg diclofenac sodium

| | pH 1.2 | pH 1.2 | pH 6.8 | pH 6.8 | pH 6.8 |
|---|---|---|---|---|---|
| Time (min) | 0 | 120 | 135 | 150 | 165 |
| Omeprazole release (%) | 0 | 2* | 93 | 97 | 97 |
| Diclofenac release (%) | 0 | 2 | 82 | 91 | 92 |

*Figure relating to the residual omeprazole content in gastric juice resistance testing in identical test conditions (pH 1.2 for 2 hours)

After the change of pH, the two active substances were released very rapidly and completely.

What is claimed is:

1. A method of producing a pharmaceutical preparation that contains a PPI (proton pump inhibitor) in the form of spherical granules (pellets), comprising the following steps:
(a) granulating the PPI, at least one basic component, at least one pharmaceutically acceptable excipient, and at least one alcohol, using a high-speed mixer, to obtain PPI-containing cores,
(b) drying the cores,
(c) coating the dried cores with an inert intermediate layer,
(d) film-coating the coated cores with an enteric layer, and
(e) drying the enteric film-coated cores to a residual moisture of less than or equal to 1.5 wt. %, to obtain PPI pellets,
wherein the impeller blade speed of the high-speed mixer is greater than or equal to 50 rev/min. and

2. The method according to claim 1, wherein the PPI is selected from omeprazole, esomeprazole, lansoprazole, pantoprazole and rabeprazole.

3. The method according to claim 1, wherein the pharmaceutical preparation further comprises an NSAID in the form of pellets, wherein the NSAID
(i) in the form of a salt, together with the PPI, is granulated, dried, coated, film-coated and dried again according to steps (a) to (e) and/or
(ii) in free form or in the form of a salt, and separately from the PPI, is granulated together with at least one pharmaceutically acceptable excipient and at least one alcohol, using a high-speed mixer, to obtain NSAID-containing cores, wherein the cores are dried, film-coated with an enteric layer and wherein the enteric film-coated cores are dried to a residual moisture of less than or equal to 4.0 wt. %, to obtain enteric film-coated NSAID pellets, and mixing the enteric film-coated NSAID pellets with the PPI pellets, wherein the impeller blade speed of the high-speed mixer is greater than or equal to 50 rev/min.

4. The method according to claim 3, wherein a first proportion of the NSAID
(i) in the form of a salt, together with the PPI, is granulated, dried, coated, film-coated and dried again according to steps (a) to (e) and/or
(ii) in free form or in the form of a salt, and separately from the PPI, is granulated together with at least one pharmaceutically acceptable excipient and at least one alcohol, using a high-speed mixer, to obtain NSAID-containing cores, wherein the cores are dried, film-coated with an enteric layer and wherein the enteric film-coated cores are dried to a residual moisture of less than or equal to 4.0 wt. %, to obtain enteric film-coated NSAID pellets, and mixing the enteric film-coated NSAID pellets with the PPI pellets, wherein the impeller blade speed of the high-speed mixer is greater than or equal to 50 rev/min and the granulation time is less than 20 minutes, and a second proportion of the NSAID is processed together with at least one pharmaceutically acceptable excipient into NSAID-containing cores and these are coated with a diffusion membrane with delayed permeability for the NSAID, to obtain delayed-release NSAID pellets, wherein the delayed-release NSAID pellets optionally are dried to a residual moisture of less than or equal to 2 wt.-%, and mixing the delayed-release NSAID pellets with the PPI pellets and optionally the enteric film-coated NSAID pellets.

5. The method according to claim 3, wherein the NSAID is selected from diclofenac, ibuprofen, ketoprofen, naproxen, indometacin, piroxicam, meloxicam, acetylsalicylic acid, celecoxib, parecoxib and etoricoxib.

6. The method according to claim 4, wherein the molar ratio of NSAID in enteric film-coated pellets to NSAID in delayed-release pellets is 0.1:1 to 1:1.

7. The method according to claim 1, wherein the PPI pellets have, after production, a water content of less than or equal to 1.0 wt. %.

8. The method according claim 1, wherein the at least one basic component is selected independently from the group consisting of: magnesium carbonate, magnesium oxide, magnesium hydroxide, aluminium carbonate, aluminium hydroxide, calcium carbonate, calcium phosphate, calcium citrate, sodium carbonate, sodium hydrogen carbonate, sodium phosphate, sodium citrate, potassium carbonate, potassium phosphate and potassium citrate.

9. The method according to claim 1, wherein the at least one excipient is selected independently from the group consisting of: mannitol, sorbitol, isomalt, colloidal silica, microcrystalline cellulose, dextrin, maltodextrin, maize starch, sucrose, lactose and sodium lauryl sulphate.

10. The method according to claim 1, wherein the inert intermediate layer is selected independently from hydroxypropylcellulose, hydroxypropylmethylcellulose, polyvinylpyrrolidone, polyvinyl alcohol and mixtures thereof.

11. The method according to claim 1, wherein the enteric layer is selected independently from: methacrylic acid-ethylacrylate copolymer, methacrylic acid-methylmethacrylate copolymer, polyvinylacetate phthalate, hydroxypropyl methylcellulose acetate phthalate, cellulose acetate phthalate, and hydroxypropyl methylcellulose acetate succinate.

12. A pharmaceutical preparation obtainable by a method according to claim 1.

13. The pharmaceutical preparation obtainable by the method according to claim 3.

14. The pharmaceutical preparation obtainable by the method according to claim 4.

15. The pharmaceutical preparation according to claim 12, wherein the at least one basic component is selected independently from the group consisting of: magnesium carbonate, magnesium oxide, magnesium hydroxide, calcium carbonate, calcium phosphate and calcium citrate.

16. A pharmaceutical preparation comprising PPI-containing and NSAID-containing pellets, wherein:
the PPI-containing pellets comprise a core, which comprises the PPI, at least one basic component and at least one pharmaceutically acceptable excipient, wherein the core is coated with an inert intermediate layer and is film-coated with an enteric layer, and
a first proportion of the NSAID-containing pellets comprise a core, which comprises the NSAID and at least one pharmaceutically acceptable excipient, wherein the core is film-coated with an enteric layer, and
a second proportion of the NSAID-containing pellets comprise a core, which comprises the NSAID and at least one pharmaceutically acceptable excipient, wherein the core is enveloped in a diffusion membrane with delayed permeability for the NSAID, wherein:
the NSAID is in free form or in the form of a salt,
the pharmaceutical preparation contains 5 mg to 40 mg, of PPI, and 50 mg to 150 mg NSAID,
the PPI is selected from omeprazole, esomeprazole, lansoprazole, pantoprazole and rabeprazole,
the NSAID is selected from diclofenac, ibuprofen, ketoprofen, naproxen, indometacin, piroxicam, meloxicam, acetylsalicylic acid, celecoxib, parecoxib and etoricoxib,
and the at least one basic component is selected independently from the group consisting of: magnesium carbonate, magnesium oxide, magnesium hydroxide, aluminium carbonate, aluminium hydroxide, calcium carbonate, calcium phosphate, calcium citrate, sodium carbonate, sodium hydrogen carbonate, sodium phosphate, sodium citrate, potassium carbonate, potassium phosphate and potassium citrate.

17. A method for treating pain and inflammation resulting from a condition selected from rheumatism, contusions, sprains and arthritis in a patient of need of said treatment, said method comprises administering to said subject the pharmaceutical preparation according to claim 13.

18. The method for treating pain and inflammation resulting from a condition selected from rheumatism, contusions, sprains and arthritis in a patient of need of said treatment, said method comprises administering to said subject the pharmaceutical preparation according to claim 14.

19. The method according to claim 1 wherein the granulation in step (a) takes place in the absence of water.

20. The method according to claim 3 wherein the granulation takes place in the absence of water.

21. The method according to claim 4, wherein the NSAID is selected from diclofenac, ibuprofen, ketoprofen, naproxen, indometacin, piroxicam, meloxicam, acetylsalicylic acid, celecoxib, parecoxib and etoricoxib.

22. The method according to claim 1 wherein in step (a), the at least one alcohol is ethanol or isopropanol.

23. The pharmaceutical preparation according to claim 13 wherein the at least one basic component is magnesium carbonate.

24. The method according to claim 3 wherein the at least one alcohol in step (i) and step (ii) is ethanol or isopropanol.

25. The pharmaceutical preparation method according to claim 14 wherein the at least one basic component is magnesium carbonate.

26. The method according to claim 4 wherein the at least one alcohol in step (i) and step (ii) is ethanol or isopropanol.

27. The pharmaceutical preparation ac to claim 15 wherein the at least one basic component is magnesium carbonate.

28. The pharmaceutical preparation according to claim 16 wherein the at least one basic component is magnesium carbonate.

29. A method for the treatment of rheumatoid arthritis, osteoarthritis or ankylosing spondylitis in a patient with a previous history or at risk of developing NSAID associated and/or duodenal ulcers which comprises administering to a patient in need thereof the pharmaceutical preparation prepared in accordance with claim 13, wherein the PPI is omeprazole.

30. A method for the treatment of rheumatoid arthritis, osteoarthritis or ankylosing spondylitis in a patient with a previous history or at risk of developing NSAID associated and/or duodenal ulcers which comprises administering to a patient in need thereof the pharmaceutical preparation prepared in accordance with claim 14, wherein the PPI is omeprazole.

31. A method for the treatment of rheumatoid arthritis, osteoarthritis or ankylosing spondylitis in a patient with a previous history or at risk of developing NSAID associated and/or duodenal ulcers which comprises administering to a patient in need thereof the pharmaceutical preparation prepared in accordance with claim 16, wherein the PPI is omeprazole.

32. The method according to claim 4 wherein the granulation takes place in the absence of water.
